(19) United States
(12) Patent Application Publication
(10) Pub. No.: US 2019/0359817 A1
(43) Pub. Date: Nov. 28, 2019

(54) MULTIFUNCTIONAL MOUSE PAID AND METHOD FOR PREPARING THE SAME

(71) Applicants: Chun-Chung LIU, Taichung City (TW); Cheng-Hui LIU, Taichung City (TW)

(72) Inventors: Chun-Chung LIU, Taichung City (TW); Cheng-Hui LIU, Taichung City (TW)

(21) Appl. No.: 16/023,250

(22) Filed: Jun. 29, 2018

(30) Foreign Application Priority Data
May 23, 2018 (CN) 201810497766.3
May 23, 2018 (CN) 201820767382.4

(51) Int. Cl. C08L 67/02; C08L 83/04; G06F 3/039; B32B 5/02; B32B 25/10; B32B 25/20

(52) U.S. Cl. CPC C08L 67/02; C08L 83/04; G06F 3/0395; B29C 43/18; B32B 25/10; B32B 25/20; B32B 5/024

(57) ABSTRACT

The present invention provides a multifunctional mouse pad, including: 200-500 parts of purified terephthalic acid, 300-600 parts of ethylene glycol, 250-400 parts of silicon dioxide, 100-150 parts of hydroxy silicone oil, and 100-200 parts of an internal mold releasing agent. The woven material of the front side of the multifunctional mouse pad has a compact molecular arrangement and is compacted, thickened and integrally woven, and thus the woven material has anti-cut, anti-chop, anti-stab, and bullet-proof functions. The back side of the multifunctional mouse pad is made of the silicone material which is a highly active and strongly-adsorbing material. The main component of the silicone material is silicon dioxide, which is chemically stable and does not burn. The mouse pad body is integrally formed with the front and back sides by thermal compression molding.

### CROSS-REFERENCE TO RELATED APPLICATION

This application claims the priority of China patent application No. 201820767382.4, filed on May 23, 2018, which is incorporated herewith by reference.

### BACKGROUND OF THE INVENTION

### 1. Field of the Invention

The present invention relates generally to a computer product, and more particularly, to a multifunctional mouse pad and a method for preparing the same.

### 2. The Prior Arts

The mouse pad refers to a small cushion for the mouse. The main function is to prevent the reflection and refraction of the surface of a special material such as glass from affecting the sensor positioning of the mouse, and to provide a plane for a mouse sensor system to conveniently calculate a movement vector.

The mouse as a standard input device is indispensable. As personal computers continue to develop, the mouse's role is gradually surpassing that of keyboards. However, as the saying goes, “a good horse with a good saddle”. There is no exception for a good mouse, and its best partner is no other than a mouse pad.

At present, the mouse pad used by people usually only facilitates the use of the mouse, and even only serves as a computer aided tool. In addition, the mouse pad does not have the effect of multifunction. Even laptops carried by the users may become targets for criminals to snatch. The users may also encounter viper and beast attacks when they are outdoors. When the users are exposed to the dangerous events either indoors or outdoors, they cannot respond in time and carry out the effective protection. Therefore, it is needed that the user can use it to get an effective protection, or to act as a counter-attack tool at the first time.

### SUMMARY OF THE INVENTION

In order to overcome the above-mentioned problems, the objective of the present invention is to provide a technical solution which can solve the above problems.

For achieving the foregoing objective, the present invention provides a multifunctional mouse pad comprising: 200-500 parts of purified terephthalic acid, 300-600 parts of ethylene glycol, 250-400 parts of silicon dioxide, 100-150 parts of hydroxy silicone oil, and 100-200 parts of an internal mold releasing agent.

The present invention provides a method for preparing a multifunctional mouse pad, comprising the following steps:
S1: carrying out an esterification and a polycondensation reaction using purified terephthalic acid and ethylene glycol as raw materials to obtain polyethylene terephthalate;
S2: lightly spinning the polyethylene terephthalate into filaments having a length of 1000 or more meters;
S3: winding the filaments in strand form, and fully drawing the filaments to obtain polyester filaments;
S4: weaving polyester filaments by warp and weft double-strand double weaving, compacting, thickening and integrally weaving to a woven material;
S5: putting silicon dioxide material, hydroxy silicone oil and an internal mold releasing agent into a kneader for processing, and controlling the temperature in the kneader at 150-180° C., and kneading for 10 minutes to obtain a mass of silica gel material;
S6: pressing silicone rubber in a pressing roller for molding, and removing the excess material to obtain a silicon rubber sheet; and
S7: integrally molding the woven material and the silica gel sheet by thermal compression molding.

As a further solution of the present invention, the internal mold releasing agent in step S5 is zinc stearate.

Compared with the prior art, the advantageous effects of the present invention are: (1) The woven material of the front side of the mouse pad has a compact molecular arrangement and is compacted, thickened and integrally woven, and thus has high strength, high tear resistance, good anti-cutting strength, excellent weather resistance, abrasion resistance, scratch resistance, puncture resistance, acid resistance, alkali resistance, mildew resistance, insect resistance, mothproof, no odor, good shock absorption and impact resistance, so that the woven material has anti-cut, anti-chop, anti-stab, and bullet-proof functions.

(2) The back side of the mouse pad is made of the silicone material, which is a highly active and strongly-adsorbing material. The main component of the silicone material is silicon dioxide, which is chemically stable and does not burn.

(3) The mouse pad body is integrally formed with the front and back sides by thermal compression molding, which is seamlessly jointed and is stable and durable.

Additional aspects and advantages will be set forth in part in the description which follows and in part will be apparent from the description, or may be learned by practice of the invention.

### DETAILED DESCRIPTION OF THE PREFERRED EMBODIMENT

The following clearly and completely describes the technical solutions in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Example 1

A multifunctional mouse pad comprises: 200-500 parts of purified terephthalic acid, 300-600 parts of ethylene glycol, 250-400 parts of silicon dioxide, 100-150 parts of hydroxy silicone oil, and 100-200 parts of an internal mold releasing agent.

A method for preparing a multifunctional mouse pad, comprises the following steps:
S1: carrying out an esterification and a polycondensation reaction using purified terephthalic acid and ethylene glycol as raw materials to obtain polyethylene terephthalate;
S2: lightly spinning the polyethylene terephthalate into filaments having a length of 1000 or more meters;
S3: winding the filaments in strand form, and fully drawing the filaments to obtain polyester filaments;
S4: weaving polyester filaments by warp and weft double-strand double weaving, compacting, thickening and integrally weaving to a woven material;
S5: putting silicon dioxide material, hydroxy silicone oil and an internal mold releasing agent into a kneader for processing, and controlling the temperature in the kneader at 150-180° C., and kneading for 10 minutes to obtain a mass of silica gel material;
S6: pressing silicone rubber in a pressing roller for molding, and removing the excess material to obtain a silicon rubber sheet; and
S7: integrally molding the woven material and the silica gel sheet by thermal compression molding.

As a further solution of the present invention, the internal mold releasing agent in step S5 is zinc stearate.

### Example 2

A multifunctional mouse pad comprises: 200 parts of purified terephthalic acid, 300 parts of ethylene glycol, 250 parts of silicon dioxide, 100 parts of hydroxy silicone oil, and 100 parts of an internal mold releasing agent.

### Example 3

A multifunctional mouse pad comprises: 350 parts of purified terephthalic acid, 450 parts of ethylene glycol, 325 parts of silicon dioxide, 125 parts of hydroxy silicone oil, and 150 parts of an internal mold releasing agent.

### Example 4

A multifunctional mouse pad comprises: 500 parts of purified terephthalic acid, 600 parts of ethylene glycol, 400 parts of silicon dioxide, 150 parts of hydroxy silicone oil, and 200 parts of an internal mold releasing agent.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A multifunctional mouse pad, comprising:
200-500 parts of purified terephthalic acid;
300-600 parts of ethylene glycol;
250-400 parts of silicon dioxide;
100-150 parts of hydroxy silicone oil; and
100-200 parts of an internal mold releasing agent.

2. The multifunctional mouse pad according to claim 1, wherein the multifunctional mouse pad comprises: 200 parts of purified terephthalic acid, 300 parts of ethylene glycol, 250 parts of silicon dioxide, 100 parts of hydroxy silicone oil, and 100 parts of the internal mold releasing agent.

3. The multifunctional mouse pad according to claim 1, wherein the multifunctional mouse pad comprises: 350 parts of purified terephthalic acid, 450 parts of ethylene glycol, 325 parts of silicon dioxide, 125 parts of hydroxy silicone oil, and 150 parts of the internal mold releasing agent.

4. The multifunctional mouse pad according to claim 1, wherein the multifunctional mouse pad comprises: 500 parts of purified terephthalic acid, 600 parts of ethylene glycol, 400 parts of silicon dioxide, 150 parts of hydroxy silicone oil, and 200 parts of the internal mold releasing agent.

5. A method for preparing a multifunctional mouse pad, comprising the following steps:
S1: carrying out an esterification and a polycondensation reaction using purified terephthalic acid and ethylene glycol as raw materials to obtain polyethylene terephthalate;
S2: lightly spinning the polyethylene terephthalate into filaments having a length of 1000 or more meters;
S3: winding the filaments in strand form, and fully drawing the filaments to obtain polyester filaments;
S4: weaving polyester filaments by warp and weft double-strand double weaving, compacting, thickening and integrally weaving to a woven material;
S5: putting silicon dioxide material, hydroxy silicone oil and an internal mold releasing agent into a kneader for processing, and controlling the temperature in the kneader at 150-180° C., and kneading for 10 minutes to obtain a mass of silica gel material;
S6: pressing silicone rubber in a pressing roller for molding, and removing the excess material to obtain a silicon rubber sheet; and
S7: integrally molding the woven material and the silica gel sheet by thermal compression molding.

6. The method according to claim 5, wherein in step S5, the internal mold releasing agent is zinc stearate.
